(19) United States
(12) Patent Application Publication
(10) Pub. No.: US 2016/0203535 A1
(43) Pub. Date: Jul. 14, 2016

(54) Network based Commerce Method and System

(71) Applicant: Trinity Nhung Nguyen, Reseda, CA (US)

(72) Inventor: Trinity Nhung Nguyen, Reseda, CA (US)

(21) Appl. No.: 14/991,838

(22) Filed: Jan. 8, 2016

Related U.S. Application Data
(60) Provisional application No. 62/101,326, filed on Jan. 8, 2015.

(51) Int. Cl. G06Q 30/06

(52) U.S. Cl. CPC G06Q 30/0609; G06Q 30/0611; G06Q 30/0617; G06Q 30/0641

(57) ABSTRACT

A commerce system is disclosed whereby a seller lists an item for sale having a fixed price, an option to receive offers, or both. If an offer is submitted, the seller may accept the offer, counter-offer, or decline the offer. The seller and buyer may exchange an unlimited number of offers and counteroffers before the listing expires. If the buyer agrees to pay the fixed price, the buyer is immediately directed to a payment service. If an offer price is agreed to, the buyer has a predetermined amount of time to pay for the item. An item is not “sold” until the payment transaction is completed. A listing ends when the last item is “sold” or the listing expires. A seller may accept multiple offers for an item from multiple buyers where the first buyer to complete the payment transaction receives the item and the other parties are notified.

### RELATED APPLICATIONS

The application claims the benefit of priority to U.S. Provisional Patent Application Ser. No. 62/101,326 entitled “Network Based Commerce Method and System”, filed Jan. 8, 2015, and currently co-pending.

### TECHNICAL FIELD

The present invention relates generally to network based commerce, and more particularly to network based commerce using a set price and offer based methods.

### COPYRIGHT NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND

Electronic commerce that utilizes the Internet to sell goods and services to customers has been increasing in its scope and scale at increasing rates. Merchants and other sellers of goods and services are increasingly in search of new mechanisms of listing their offered goods and services to leverage this growth in electronic commerce.

However, despite this growth in electronic commerce, sellers and buyers have been reluctant when dealing with certain types of products and services because current electronic commerce mechanisms do not accurately reflect non-electronic commerce transaction process. As a result, perceptions exist that sellers do not obtain maximized prices for their products or services and do not have control over the final selling price. In addition, some buyers are not comfortable with current electronic commerce processes, such as online auctions, which do not resemble most non-electronic transaction processes.

Further challenges exist for sellers and buyers working to ensure they maximize their positions in transactions. Current processes provide sellers with the ability to set terms of sale and a set price that a seller is willing to accept. Additional processes allow sellers to accept offers for their items but typically those processes limit the amount of negotiation between the seller and a potential buyer. Because of a lack of control over transaction terms in an auction like setting, some sellers lose potential buyers due to a limited number of buyers for an item. Some buyers are reluctant to purchase, or even consider, an offered product or service since they are forced to wait for the item and can be manipulated by other buyers by forcing someone to continually monitor and outbid other potential buyers. In an offer based transaction, a potential buyer may have to wait days for a seller to respond to an offer, thereby extending the process over several days, potentially leading to the potential buyer losing interest in the transaction. This reluctance has a constraining effect on electronic commerce.

### SUMMARY

According to a preferred embodiment of the present invention, there is a network based commerce system allowing a seller to list items for sale where the item can be a good, a service, or a combination of goods and services. If the item involves a service, the Buyer may also view and purchase an available time slot, if necessary, for the performance of the service.

In the listing, the seller has two (2) different options. The first option is to only have a fixed price where the buyer must pay that fixed price if they want to purchase the item immediately. The fixed price is the price set by the Seller when creating the item listing and the price the Seller is willing to immediately sell the item without any negotiation. The fixed price is displayed in the item listing to a potential Buyer when the potential Buyer views the Seller's listing. A Buyer may agree to the fixed price then complete the payment transaction to receive the item. A payment transaction is considered complete when a payment verification indication is received by the commerce system in response to a request from the commerce system to a third party financial institution to process a payment using financial information provided by the Buyer.

The second option is to allow a buyer to make an offer for the item. When implementing the offer option, a seller may set a minimum floor price and a negotiation price, both of which are hidden from the buyer. The minimum floor price is the lowest price that a seller is willing to sell an item. The negotiation price, which is less than the minimum floor price, is the price set by the seller where if the offer price is below the negotiation price, the commerce system will automatically declines the offer and notifies the Buyer that his or her offer has been declined. If the offer price is above the negotiation price but below the minimum floor price, the commerce system sends the Buyer's offer to the Seller where the Seller then has the option, through the commerce system interface, to accept the Buyer's offer, decline the offer, or return a counteroffer to the Buyer through the commerce system interface . . . . If the buyer's offer falls between the fixed price and the minimum floor price, the offer is automatically accepted by the commerce system and the buyer is directed to a page where the financial aspect of the transaction is completed. Only when the buyer completes the payment transaction is the item considered sold and is taken off the website. The item's available quantity is reduced only by the number of item units paid for in the completed payment transaction, and the listing is automatically taken off the website by the commerce system when the item's available quantity goes to zero (0). If the item's available quantity is greater than zero (0), the item will remain listed on the website showing the new available quantity. If the offer is below the minimum floor price but above the negotiation price, then the seller is notified by the commerce system of the offer and the negotiation process begins between the buyer and the seller where both the buyer and the seller have a predetermined period of time after receipt of the last notification from the commerce system of each offer to respond. If the Buyer or Seller fails to respond to a notification from the commerce system within the predetermined period of time, the offer(s) will automatically become void. When the buyer and seller both agree to a negotiated offer price, then the buyer must complete the financial aspect of the transaction within a predetermined period of time or the buyer will not receive the item and the buyer's offer will become void. If the buyer's offer falls below the negotiation price, then the buyer is immediately notified through the user interface that the offer has been declined.

During the duration of an item's listing, multiple buyers may agree to either pay the listed fixed price for the item or have multiple accepted offers for that item even if the item has an agreement from another Buyer to pay the fixed price, has received other offers, has accepted one or more of the other offers, or the commerce system has automatically accepted other offers. The item will remain listed and available on the commerce system as long as the item still has an available quantity. The item will only be removed from the commerce system when a payment transaction is complete and the available quantity is decremented to zero (0). The first buyer to complete the payment transaction for the item, whether through agreement to pay an offer price or to pay the fixed price, will receive the item. Sellers can change the offer anytime as long as the item is still listed and there are no active offers for the item. Further, the item will remain listed as on sale or for sale until the buyer completes the payment transaction. Once the first buyer completes the payment transaction within the predetermined time period and the available quantity is zero, a communication is sent to the other potential buyers, if there are any, to inform them that the item has been sold and is no longer available. If more than one of the items is available for purchase through the listing, then the system will decrease the number of items available to reflect the completed payment transaction by the buyer until the available quantity reaches zero. When the available quantity reaches zero, a communication is sent to the buyers that have agreed to purchase the item but have faded to complete the payment transaction to notify them that the item(s) has been sold and is no longer available. When the item quantity available goes below a level set by the seller, a restock alert is generated by the system and sent to the seder to alert the seller that the item needs to be restocked. When the seller has more stock to add to the listing, the seller may or may not update the listing to reflect the new quantity available for sale.

If an offer or counter-offer is declined by the seller, then the buyer may submit a new offer for that item. In some embodiments, a buyer may submit an unlimited number of offers for the same item or any item during the life of the listing. Other embodiments limit the number of offers a buyer is allowed to make for a specific item. For example, the commerce system sets the limit for the a buyer to make an offer per item. After, for example, the third offer, the System prevents the Buyer from making another offer for that item for one hour. After the hour is up, the System again allows the Buyer to make another offer for that specific item. If the seller provides a counter-offer, then the buyer has a predetermined amount of time to respond to the counter-offer with either an acceptance of the counter-offer, make another counter-offer, or decline the offer. In certain embodiments, the buyer and seller may exchange offers and counter-offers an unlimited number of times until either an agreed upon price is reached or the predetermined time to reply to the latest offer or counter-offer expires. Other embodiments limit the number of offers and counter-offers the buyer and seller may exchange, which may include the designation of a time period after the submission of an offer during which that potential buyer may not submit another offer. The time period may be set by the system operator.

In another embodiment, if a buyer fails to pay for an item within the predetermined time after the seller accepts the offer, a seller may generate a “strike” against the buyer. For example, if a Buyer fails to complete the payment transaction for an item within a predetermined of time, the Seller may generate a “STRIKE” against that Buyer. If the Buyer receives a specified number of “STRIKES”, the commerce system will suspend any further transactions involving that Buyer.

The commerce system also allows for a Buyer to “FLAG” a Seller if the Seller fails to perform his or her duties associated with the transaction of an item. For example, if a seller fails to deliver an item to a buyer after the buyer pays for the item, misrepresents an item, or fails to adequately communicate with the buyer, a “flag” is generated against the seller. After a Seller is “flagged” a predetermined number of times by a multiple number of buyers, the seller's listing will be removed from the site. The listing may be reinstated at the discretion of the system operator. When an item is reinstated, the number of “flags” against the item is set back to zero (0). Further, a buyer is given the ability to rate the seller based on the buyer's experience with the seller. For example, if a seller fails to deliver an item, a buyer may give the seller a low rating.

If a seller timely delivers the item and the item matches the description in the item listing, then the buyer may give the seller a high rating. In some embodiments of the present invention, a seller's rating is displayed in the item listing or on the seller's homepage for potential buyers to view prior to agreeing to pay the fixed price or submitting an offer using the item's offer option. Once an item is reinstated, it cannot be flagged again for the duration of the listing by any buyer. The listing ends when the duration time period of the listing expires or all available quantities of the item are sold through completion of the payment transaction. If the item is re-listed, it is considered a new item and may again be flagged by any buyer for the duration of the new listing.

In yet another embodiment, a listing for an item will expire after a predetermined period of time set by the system operator if the item is not purchased. In such a case, the seller has the right to relist the item at the same or different price.

In certain embodiments of the present invention, fees are charged by the commerce system of the present invention to the Seller and the Buyer. Fees include listing fees and make an offer fee. The fees charged cover each item sold, not each transaction, and are only charged when an item sells, not when a Seller lists an item or when a Buyer submits an offer for the item. For example, if a buyer purchases two (2) units of an item in the same transaction, the buyer is charged a fee for each unit. If a buyer purchases five (5) units of an item in a single transaction, the buyer is charged a fee for each of the five (5) units, not for the single transaction. A Buyer pays any fees due at the time of payment.

A Seller pays fees when the item(s) sell and not when an item is listed on the System. If a Seller creates a listing for a group of items where the buyer may only buy the group of items and not the individual items, the commerce system charges fees based on the sale price of the group of items, not on the individual items included in the package.

Other functions of the commerce system of the present invention include the ability for a seller or wholesaler to dropship to a specific location, fundraising for nonprofit organizations and schools, listing appointment time slots for a service, managing and tracking existing appointments including cancellations, listing deadlines, and stipulations, as well as shipping fees based on the number of items purchased by a Buyer.

### BRIEF DESCRIPTION OF THE DRAWINGS

The present invention is illustrated by way of example and not limitation in the figures of the accompanying drawings, in which like references indicate similar elements and in which;

FIG. 1 is a block diagram of an exemplary commerce system showing a central computing system, a seller's computing system, and a buyer's computing system connected through local networks to the internet;

FIG. 2 is a process flow chart according to one embodiment of the present invention showing a process for purchasing an item through negotiation involving offers and counter-offers;

FIG. 3 is a process flow chart according to an alternative embodiment of the present invention showing a process for purchasing an item at a fixed price;

FIG. 4 is a process flow chart according to an embodiment of the present invention showing a “strike” system for tracking buyers that fail to perform their duties associated with the sale of an item; and

FIG. 5 is a process flow chart according to an embodiment of the present invention showing a “flag” system for tracking sellers that fail to perform their duties associated with the sale of an item;

FIG. 6 is a process flow chart according to an embodiment of the present invention showing process for when a buyer makes an offer for an item where the offer exceeds the fixed price;

FIG. 7 is a process flow chart according to an embodiment of the present invention showing a restock alert process that allows a seller to adjust available quantity;

FIG. 8 is a process flow chart according to an embodiment of the present invention showing the reduction process of the available quantity for sale of a listed item;

FIG. 9 is a process flow chart according to an embodiment of the present invention showing the first Buyer that completes the payment transaction receiving the item and notifying other Buyers that the item has been sold;

FIG. 10 is a flowchart showing the application of tier fees as applied to a transaction;

FIG. 11 is a process flowchart showing the application of shipping charges set by the Seller and charged to the Buyer for each transaction;

FIG. 12 is a process flowchart showing the process for buyers to make an offer to a seller;

FIG. 13 is a process flowchart showing how a seller automatically accepts multiple offers for an item through the commerce system where the item remains listed on the commerce system until there is a complete payment transaction; and

FIG. 14 is a process flowchart showing the process of receiving multiple offers by the commerce system as well as a purchase using the fixed price option.

### DETAILED DESCRIPTION

In the embodiments described below, the commerce system described provides sellers and buyers an option to buy or sell at a fixed price, at an offer price agreed to between the buyer and seller agreed to through offers and counteroffers, or a combination of the two. The commerce system is a computer based system that is connected to a network and is capable of transmitting and receiving information. The commerce system also provides tools to the buyers and sellers allowing them to quickly and easily manage their items, such as user interfaces specific to the commerce system. If a buyer agrees to pay the fixed price for the item, the buyer is immediately directed to a payment service to complete the transaction. If a Buyer and Seller negotiate and agree to a final price, the buyer has a predetermined amount of time to complete the transaction by paying for the item through a payment service. Once the financial transaction is complete, the item is paid for, the quantity of the item is reduced by the amount purchased by the buyer in the completed payment transaction, and the listing is removed if the item's quantity available is reduced to zero.

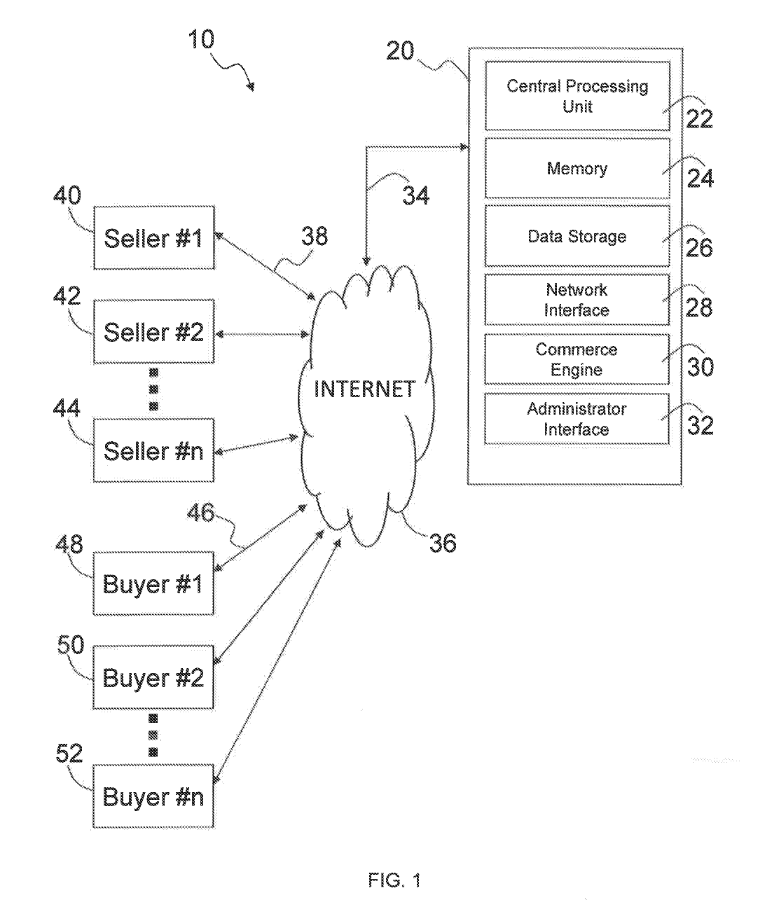

In FIG. 1, a block diagram of an exemplary commerce system of the present invention is shown and referred to as 10. Central computer 20 may be any type of computing platform known in the industry and generally consists of a central processing unit 22, memory 24, a data storage device 26, a network interface 28, the commerce engine of the present invention 30, and an administrator interface 32. Administrator interface 32 allows for a system operator to monitor, update, configure, and communicate with the commerce engine 30 and the central computer as a whole. Network interface 28 allows central computer 20 in connect through local network 34 to the internet 36. It is to be appreciated by one skilled in the art that the internet 36 and central computer 20 may be replaced with a cloud computing system known in the art and will not change the overall functionality of the commerce system of the present invention.

Seller #1 40, Seller #2 42, and Seller #n 44 connect through their respective local networks 38 to the Internet 36 thereby allowing communication between central computer 20 and each of the Sellers 40, 42, and 44. Buyer #1 48, Buyer #2 50, and Buyer #n 52 connect through their respective local networks 46 to the internet also allowing them to communicate with central computer 20. Offers, counter-offers, agreements to pay a fixed price for an item, listing information such as available quantity, restock alert setting, and other pieces of information associated with a listing as well as communications regarding the status of a listing and purchases can be communicated between the Sellers 40, 42, and 44, the Buyers 48, 50, and 52, and the central computer 20 through the local networks 34, 38, and 46 and the Internet 36.

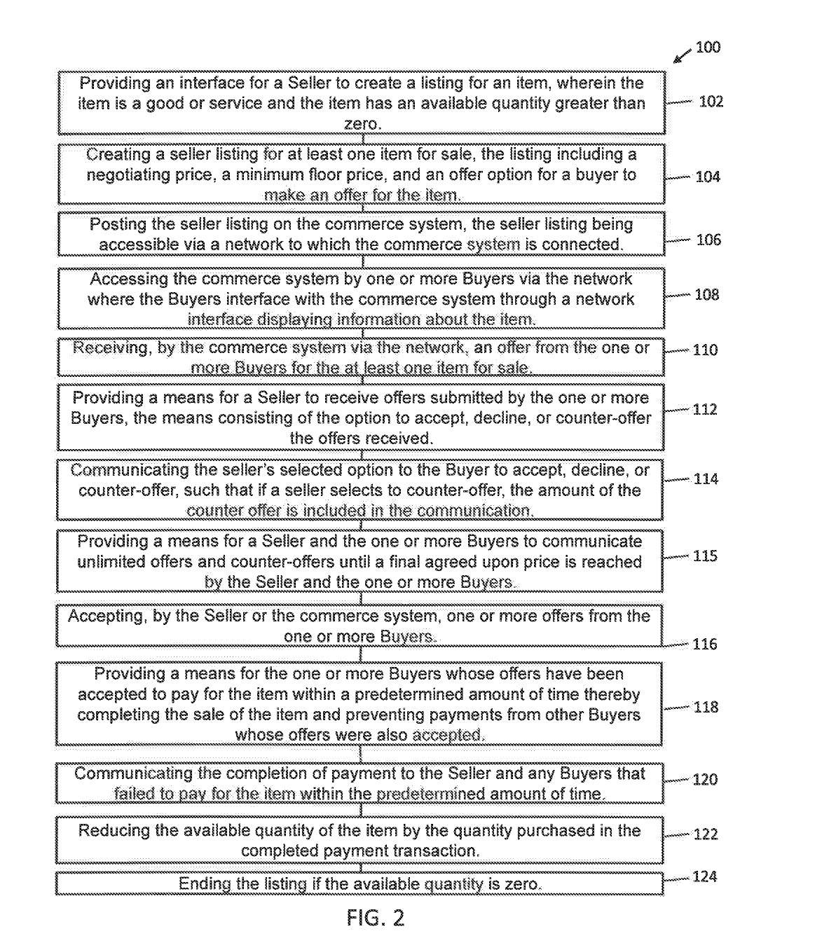

Regarding FIG. 2, an exemplary process is shown and designated 100. In process 100, the commerce system provides an interface to a seller to create a listing for an item 102. The item can be a good, a service, or a combination of goods and services. A good is a tangible object, such as engine oil, where a service requires the performance of an act, such as an oil change. In step 104, the seller creates a listing for an item, which may include an option to accept offers for the item, a fixed price, or a combination of the two. When the Seller selects the option to accept offers, the seller may also set a negotiating price and a minimum floor price. If an offer is submitted for an item that is below the negotiating price limit, the commerce system will automatically reject the offer. The seller may also set a minimum floor price. If an offer is submitted that is above the minimum floor price, then the system will automatically accept the offer. If a buyer submits an offer that is above the fixed price, the buyer is presented with the options to continue with the offer price, to submit a new offer, or purchase the item at the fixed price. In step 106, the listing created in step 104 is posted to the commerce system, which becomes accessible through the network. In creating the listing, the seller may also include a description of the item, select one or more categories for the item, may also include images of the item. Further, the seller may configure the listing to adjust the shipping cost based on the quantity of items purchased by the buyer through the commerce system. The sellers are able to set the discount shipping depending on the quantities purchase in one transaction for either a ‘fix price’ or ‘make me an offer price’. For example, a seller may charge $2.00 per item for shipping if a buyer purchases up to ten (10) items, but if a buyer purchases more than ten (10) items, then the seller may charge only $1.00 per item for shipping. As another example, if the shipping cost for a jacket is $10.00 per jacket and the Seller set the discount for shipping at $5.00 per jacket for the purchase of 3 or more jackets. Since the buyer made an offer for 5 jackets, the buyer will receive the shipping discount from the seller at $5.00 per jacket. If, the buyer purchases or made an offer for only 2 jackets, the buyer will not receive the shipping discount from the seller since the seller set the discount for the purchase of 3 or more jackets per transaction.

Step 108 has one or more buyers accessing the commerce system through the network. A user interface is provided by the commerce system showing items listed by various sellers. A buyer may search the commerce system by using either keywords or partial keywords associated with an item, a specific Seller's store, or by scrolling through various categories, such as “beauty products”, “jewelry”, or “electronics”. It is to be appreciated that many different categories may be listed and that an item may be listed in more than one category. When a buyer locates an item of interest, step 110 has the commerce system receiving an offer from the buyer for the item of interest. In step 112, the seller is notified of the offer and is presented with the option to accept the offer, counter-offer, or decline the offer. In step 114, the seller's selected option to accept the offer, counter-offer, or decline the offer is communicated to the buyer. If the seller sends a counter-offer, the counter-offer includes an amount the seller is currently willing to accept for the item. In step 115, the commerce system provides the Seller and a Buyer with the ability to exchange unlimited offers for the item until a final price is agreed to by the Seller and the Buyer. In step 116, a buyer and seller can exchange an unlimited number of offers or counter-offers until either a price is agreed to by the Seller and Buyer for the item or the negotiation process terminates. The negotiation process may terminate by allowing an offer or counter-offer to expire before responding to it or by the seller declining an offer and the buyer does not submit a new offer.

After a final price is agreed upon by the buyer and the seller, step 118 has the buyer using a payment system, such as PayPal™, to complete the financial transaction for the item. The buyer must complete the financial transaction the item within a predetermined amount of time to complete the transaction. When payment is made, the transaction is complete, the item is considered as “sold”, and a communication is sent to any other buyers that have had their offer accepted by the buyer but have yet to complete the financial transaction for the item. This means that the seller may accept multiple offers for an item, even if only one item is available. In step 120, the completion of the payment transaction is communicated to the seller and the other buyers are notified that the item is no longer available unless the seller has additional quantities available for sale.

In step 122, the available quantity is reduced by the quantity purchased by the buyer when the buyer completes the payment transaction for the item. In step 124, the listing is ended if the available quantity is reduced to zero (0) in step 122. The listing may also end if the item does not sell within a predetermined amount of time set by the system operator. For example, a listing may remain active for three (3) weeks before the commerce system automatically ends the listing. Additionally, the seller may end the listing by removing the listing from the commerce system at any time while the listing is active in the commerce system.

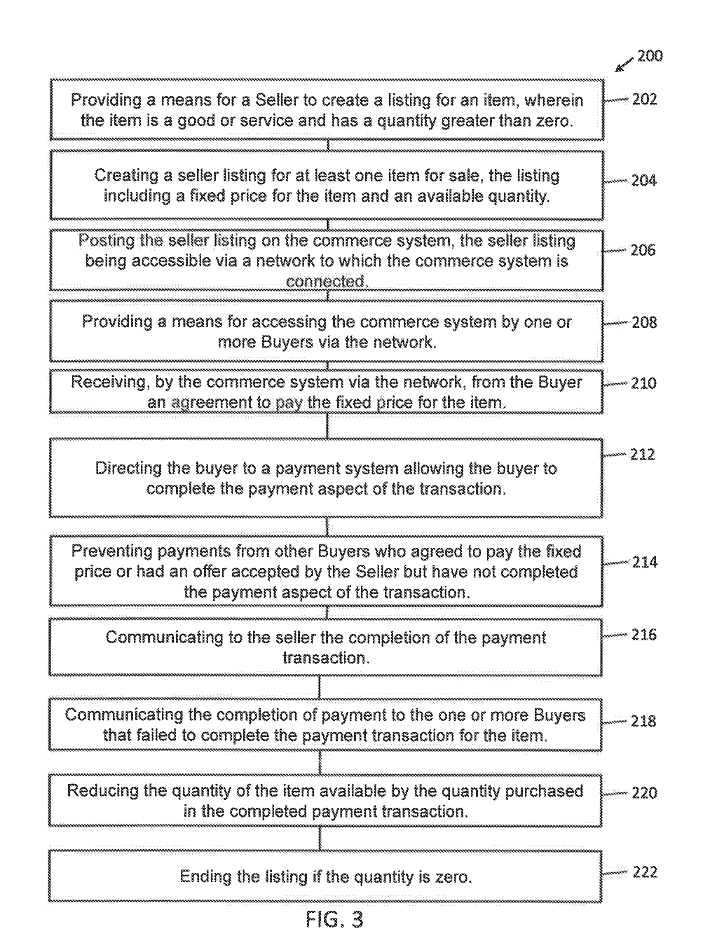

Referring now to FIG. 3, an alternative process for purchasing an item is shown and designated 200. In step 202, the commerce system provides a seller with an interface allowing the seller to create a listing for an item, similar to step 102 described above. In step 204, the seller sets a fixed price and inputs the quantity available for the item. In creating the listing, the seller may also include a description of the item, select one or more categories for the item, may include images of the item, and may adjust the shipping cost based on the quantity purchased by the buyer through the commerce system.

In step 206, the listing created by the seller in step 204 is posted on the commerce system which is accessible via the network to which the commerce is connected. In Step 208, one of more buyers can access the commerce system through a user interface generated by the commerce system over the network. If a buyer desires to pay the fixed price for the item, then step 210 has the commerce system receiving the buyer's agreement to pay the fixed price for the item. In step 212, the buyer is directed to a payment system, such as PayPal™, to complete the payment aspect of the transaction.

After the buyer has completed the payment aspect of the transaction, step 214 has the commerce system preventing payments from other buyers who agreed to pay the fixed price or had an offer accepted by the seller but have not completed the payment transaction.

Once payment is complete, the item is considered as “sold” and step 216 has the payment completion communicated to the seller. It is to be appreciated by someone skilled in the art that the buyer that receives the item may not have been the first buyer to agree to pay the fixed price. The outcome of the transaction is ultimately determined by the first buyer to complete the payment transaction for the item.

After the transaction is complete and the item is “sold”, step 215 communicates to any other buyer that had agreed to pay the fixed price or had an offer accepted by the seller for the item but had not completed the payment transaction. Step 220 reduces the quantity available for the item by the quantity purchased by the successful buyer. In step 222, the listing is ended if the available quantity is reduced to zero in step 220.

It is to be appreciated by someone skilled in the art that the process steps illustrated in FIG. 2 and FIG. 3 may be practiced together in the same listing. In practice, this means that an item may be listed with a fixed price as well as an invitation to make an offer for the item. A buyer may choose to either pay the fixed price or submit an offer for the item. Depending on the actions of the buyer, the purchase process will be completed through the steps listed in FIG. 2 or in FIG. 3.

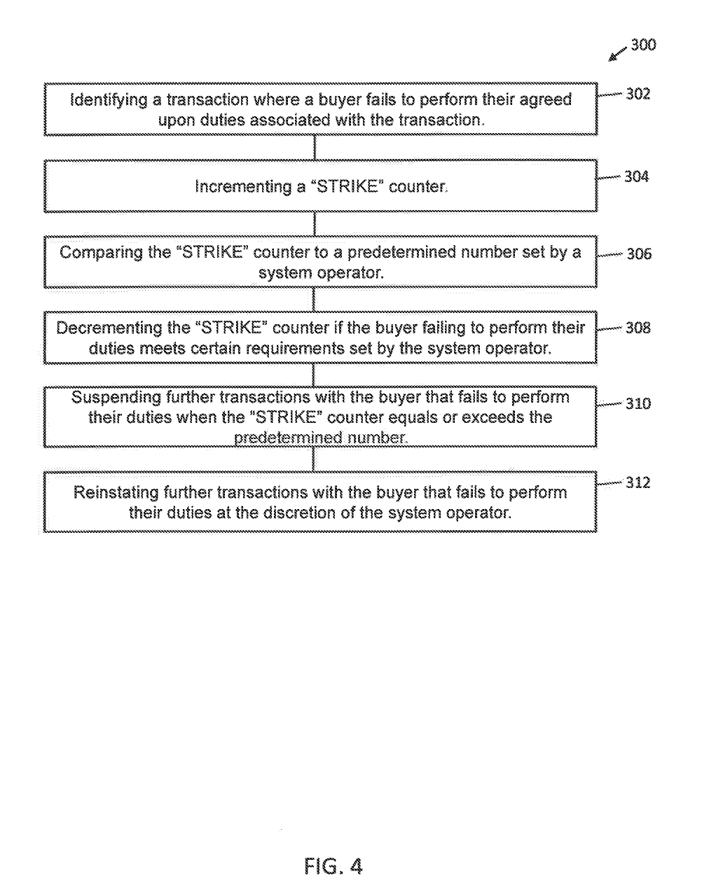

Referring now to FIG. 4, a process for tracking failures by a buyer is disclosed and referred to as 300. In step 302, the commerce system identifies a transaction where a buyer fails to perform their agreed upon duties associated with the transaction. For example, a buyer may fail to make payment for the item within the predetermined amount of time. If a buyer fails to perform their duties associated with a transaction, step 304 has the commerce system generating a “STRIKE” against a buyer and incrementing a “STRIKE” counter. In an alternative embodiment, the seller generates a “STRIKE” against the buyer instead of the commerce system thereby causing the “STRIKE” counter to increment. In step 306, the commerce system compares the “STRIKE” counter to a predetermined number set by the system operator. For example, the predetermined number may be five (5) for a buyer. If the “STRIKE” counter is at a number above zero, step 308 allows the “STRIKE” counter to be decremented if the buyer meets certain requirements set by the system operator. When a buyer receives a “STRIKE”, the buy starts a three (3) month probationary period. It is to be appreciated by someone skilled in the art that the length of the probationary period may vary at the discretion of the system operator. For example, a buyers “STRIKE” counter may be decremented if the buyer successfully completes a transaction, which includes payment, for at least one item from three (3) different sellers within the probationary three (3) month time period, and receives no additional strikes within that three (3) month period. If the Buyer receives another “STRIKE” during the probationary time period, the probationary time period is reset to the beginning of the most recent strike. If after decrementing the buyers “STRIKE” counter and the buyers counter is still above zero (0), the buyer starts a new three (3) month probationary period to have the next “STRIKE” drop off. The process then repeats itself until the buyer's “STRIKE” counter is zero (0). Alternatively, the buyer may petition the system operator to remove one or more strikes from the buyers strike counter at the discretion of the system operator.

A buyer may only receive one (1) strike per item per buyer offer. If a buyer makes multiple offers for one item from the same seller, only one strike may be given to the buyer. Sellers with multiple listing may still strike the same buyer that made different offers for different listings, therefore the buyer may receive more than one Strike from the same seller for those different listing offers. The seller will have to give a reason why he or she is giving a strike to the buyer.

In step 310, a buyer's account is suspended if the “STRIKE” counter reaches or exceeds the predetermined number. Lastly, in step 312, the buyer may have their account reinstated at the discretion of the system operator.

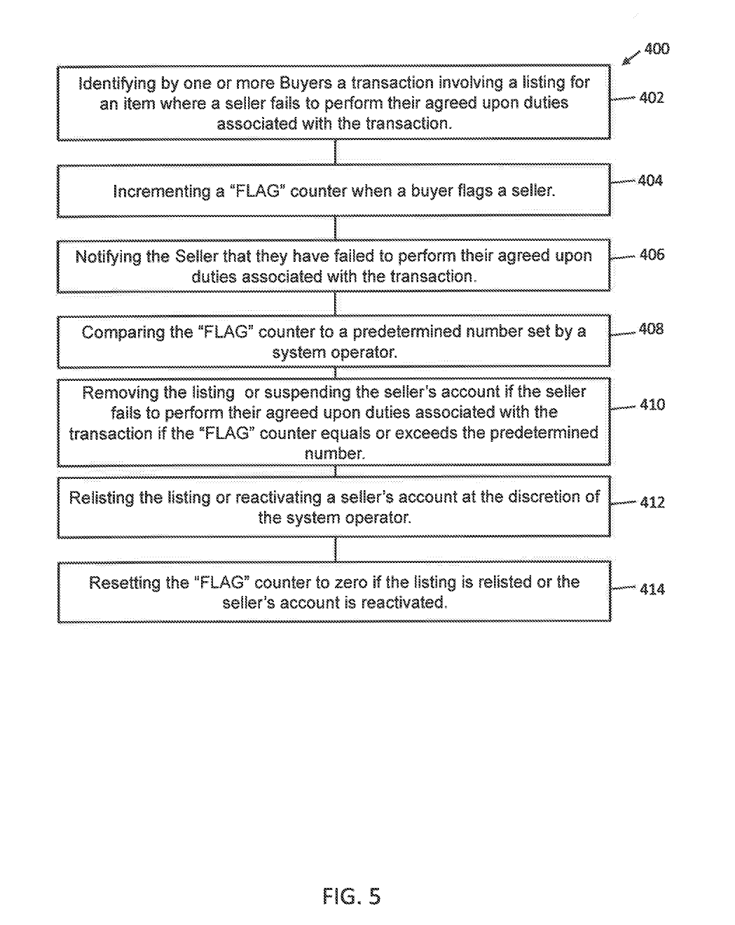

Referring now to FIG. 5, a process for tracking failures by a seller is disclosed and referred to as 400. In step 402, the commerce system identifies a transaction where a seller fails to perform their agreed upon duties associated with the transaction. For example, a seller may fail to deliver an item after payment is received or misrepresented an item in the listing. If a seller fails to perform their duties associated with a transaction, step 404 has the commerce system increment a “FLAG” counter associated with the seller. In an alternative embodiment, a seller may be flagged by a buyer as well as the commerce system. In step 406, the commerce system notifies the seller that they have failed to perform their agreed upon duties associated with the transaction, such as failing to deliver an item after it has been paid for or misrepresenting the item in the listing, hi step 408, the commerce system compares the “FLAG” counter to a predetermined number set by the system operator. Step 410 has the commerce system removing the listing if the seller fails to perform their agreed upon duties associated with the transaction if the “FLAG” counter equals or exceeds the predetermined number. In an alternative embodiment, the commerce system suspends the seller's account when the “FLAG” counter equals or exceeds the predetermined number.

After the listing is removed in step 410, step 412 has the listing relisted or the seller's account reactivated at the discretion of the system operator. If the listing is relisted or the seller's account reactivated, the “FLAG” counter is reset to zero in step 414.

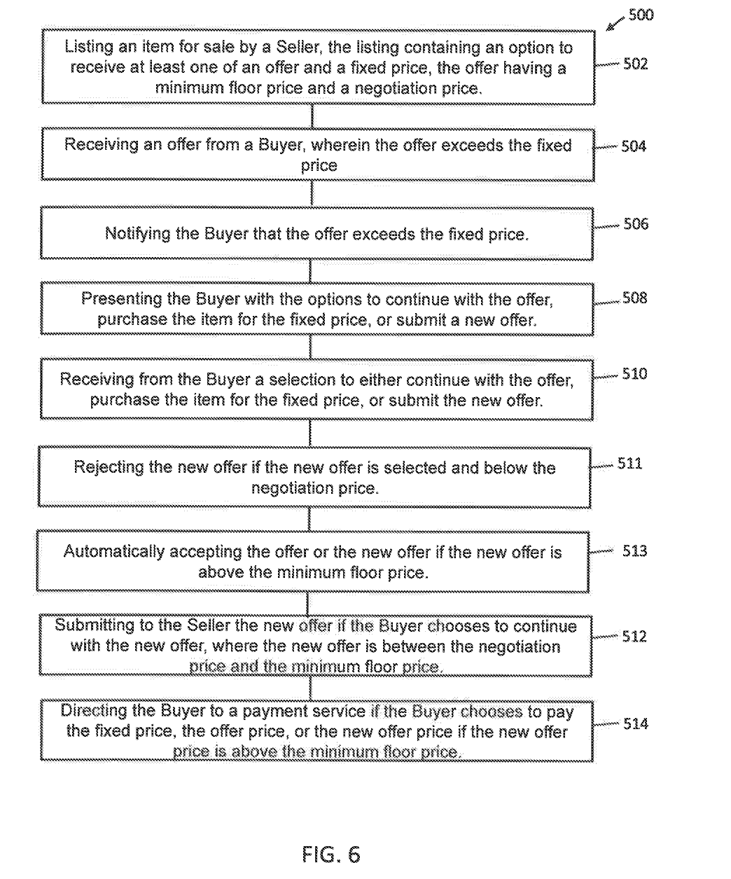

Referring now to FIG. 6, a process flow chart for offers received that are above the fixed price is disclosed and referred to as 500. In Step 502, a listing for an item is created by a Seller where the listing contains a fixed price or an option to submit an offer for the item. The offer option includes a minimum floor price and a negotiation price. Step 504 has the Seller receiving an offer from a Buyer where the submitted offer price is greater than the fixed price. The Buyer is notified in step 506 that the offer exceeds the fixed price. In Step 508, the Buyer is presented through the user interface three (3) options associated with the submitted offer price. The options are for the Buyer to continue with the submitted offer, purchase the item at the fixed price, or submit a new offer.

In Step 510, the commerce system receives the Buyers selection to continue with the offer, purchase the item at the fixed price, or submit the new offer. Step 511 has the commerce system rejecting the new offer if the buyers chooses to submit a new offer and the new offer is below the negotiation price. Step 513 has the commerce system automatically accepting the original offer or the new offer if the new offer is above the minimum floor price. If the Buyer chooses to continue with the original offer or submit a new offer, step 512 has the original offer or the new offer submitted to the Seller. If the Buyer chooses to pay the fixed price, the original offer price, or the new offer price if the new offer price is above the minimum floor price, then step 514 directs the Buyer to a payment service where the Buyer must complete the payment transaction for the item in order for the Buyer to receive that item. If after completing the payment transaction the quantity available is zero (0), the listing is removed and no longer viewable by any buyer.

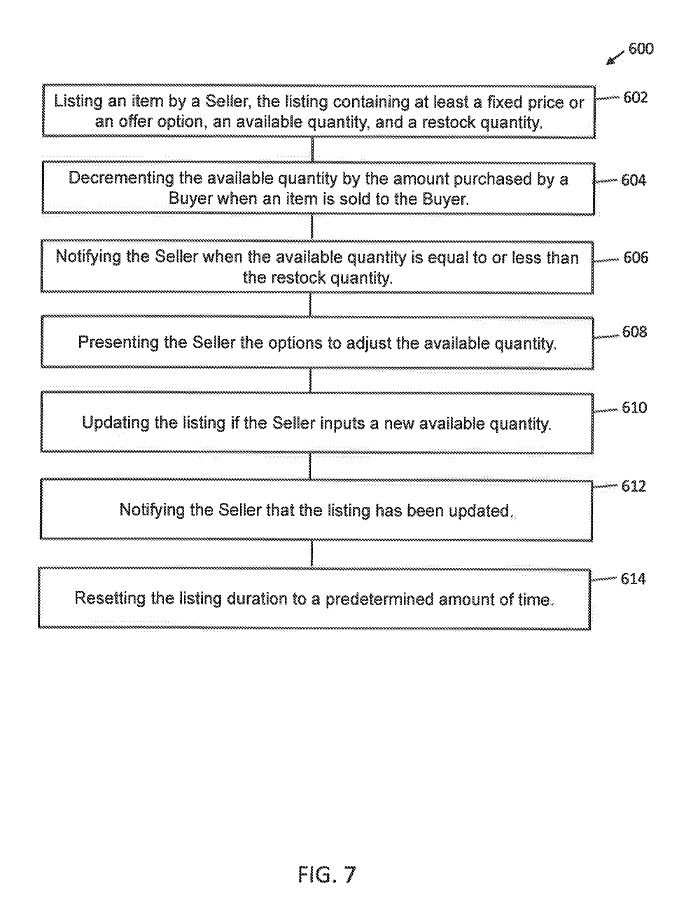

Referring to FIG. 7, a process flow chart for a restock alert is shown and designated 600. In step 602, a Seller lists an item, where the listing contains at least a fixed price or an option to receive an offer for the item, an available quantity, and a restock quantity. The restock quantity is set by the seller and may be reset at any time to the original quantity or a new quantity. In step 604, the available quantity is decremented by the amount sold to a Buyer after the payment process for the transaction is completed by the buyer. For example, if the available quantity is “10” and a Buyer purchases “4” of the items, the available quantity is decremented to “6”. In step 606, if the resulting available quantity from step 604 is equal to or less than the restock quantity, the Seller is notified.

After the Seller is notified in step 606, step 608 presents the Seller with the options to adjust the available quantity for the item. In some embodiments, at the time the seller resets the restock quantity, the seller has the choice of continuing with the existing listing or creating a new listing, where the new listing gets a new time duration, which is typically 21 days. If the seller also decides to change, any content in the listing, the seller must create a new listing having the new information since once a listing is posted, the core information, such as the item description, cannot be changed. If the Seller updates the available quantity, step 610 updates the listing with the new available quantity. Lastly, step 612 notifies the Seller that the listing has been updated. Step 614 then resets the duration of the listing to a predetermined amount of time. For example, when the listing is updated, the duration of the listing may be reset to twenty-one (21) days. A listing will expire after the twenty-one (21) days.

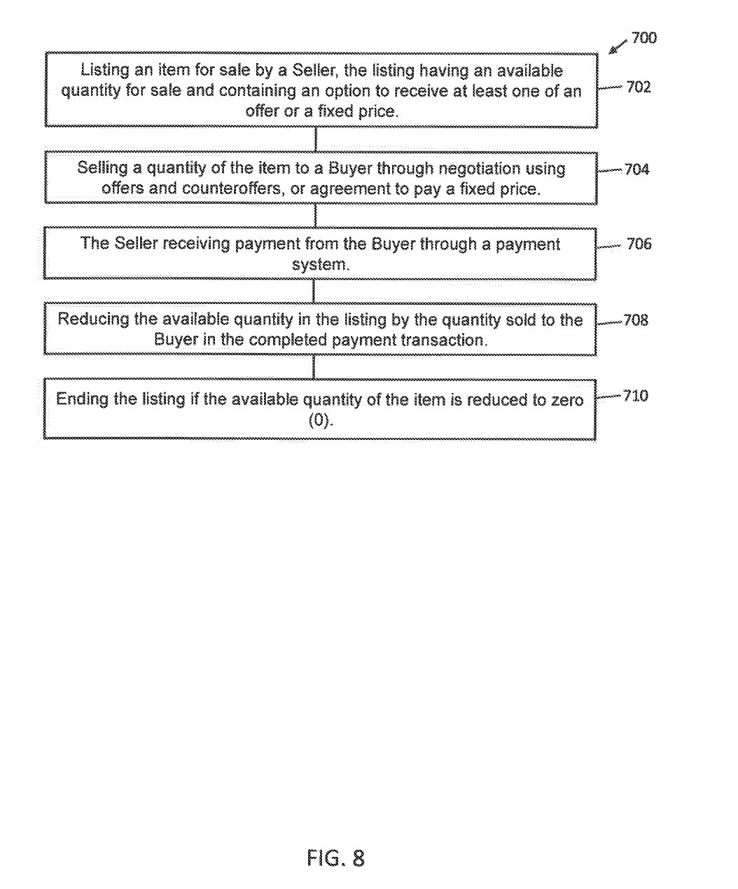

Referring now to FIG. 8, a process flow chart showing the reduction in the available quantity is shown and referred to as 700. In step 702, a listing is created by a Seller where the listing contains an available quantity for sale and at least one of an option to receive an offer and or a fixed price for the item. In step 704, a quantity of the item is sold to a Buyer either through a negotiation process associated with the option to accept an offer or an agreement to pay the fixed price for the item(s). The Seller receives payment through a payment system, such as PayPal™, in step 706. In step 708, the available quantity in the listing for the item is reduced by the quantity purchased by the Buyer by the completed payment transaction. For example, if the available quantity is “10” and the Buyer purchases “4” of the item, then the available quantity in the listing is reduced to “6” when the buyer completes the payment transaction for the item. If the buyer does not complete the payment transaction for the item within the predetermined time period, the item will remain listed on the commerce system for the duration of the item's listing. Lastly, the listing is ended in step 710 if the available quantity for the item is reduced to zero (0).

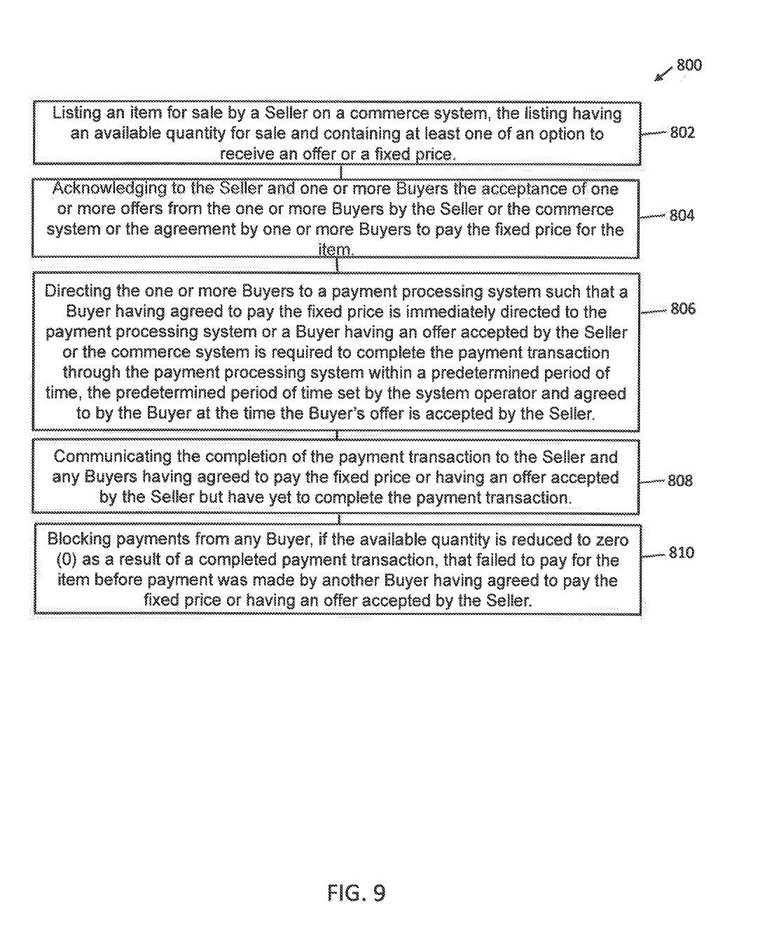

Referring to FIG. 9, a process flow chart showing the first Buyer to complete the payment process as receiving the item(s) is shown and referred to as 800. In step 802, a Seller creates a listing for an item for sale, where the listing contains an available quantity for sale and containing at least one of an option to receive an offer or a fixed price. In Step 804, the commerce system sends an acknowledgement to the Seller and one or more Buyers the automatic acceptance by the commerce system or agreement by the Buyer to pay the fixed price or the acceptance by the Seller of an offer from the Buyer. It is to be appreciated by one skilled in the art that the Seller may accept multiple offers from multiple Buyers and that other Buyers may simultaneously agree to pay the fixed price or a different offer price for the item, all while the listing has not ended.

In step 806, the Buyers that agree to pay the fixed price are immediately directed to a payment processing service, and the Buyers that have an offer accepted by either the Seller or the commerce system are given a predetermined amount of time to complete the payment transaction through a payment processing system. The predetermined amount of time is set by the system operator. The predetermined amount of time is agreed to by the Buyer at the time the Buyer's offer is accepted by either the Seller or the commerce system. In step 808, the completion of the payment transaction is communicated to the Seller and any Buyers having agreed to pay the fixed price or had an offer accepted by either the Seller or the commerce system but have yet to complete the payment transaction for the item. If the number of items purchased by the one or more Buyers in step 806 causes the available quantity of an item to be reduced to zero (0), step 810 blocks payments from any other Buyers that either agreed to pay the fixed price for the item or had an offer accepted by the Seller but have not yet completed the payment transaction for the item. For example, if there are ten (10) items available for sale, the Seller may accept, or the commerce system may automatically accept, six (6) offers for one (1) of the items from six (6) different Buyers while five (5) buyers agree to pay the fixed price for one (1) item each for a total of eleven (11) items. As each Buyer completes the payment transaction, thereby receiving their purchased amount of items, the available quantity of items is reduced by the number of items purchased in each completed payment transaction. When the available quantity is reduced to one (1), the first buyer to complete the payment transaction receives the item. When the last available item is purchased through completion of the payment transaction, the remaining Buyer(s) is(are) blocked from completing the payment transaction, the item listing is ended, and the listing is removed from the commerce system.

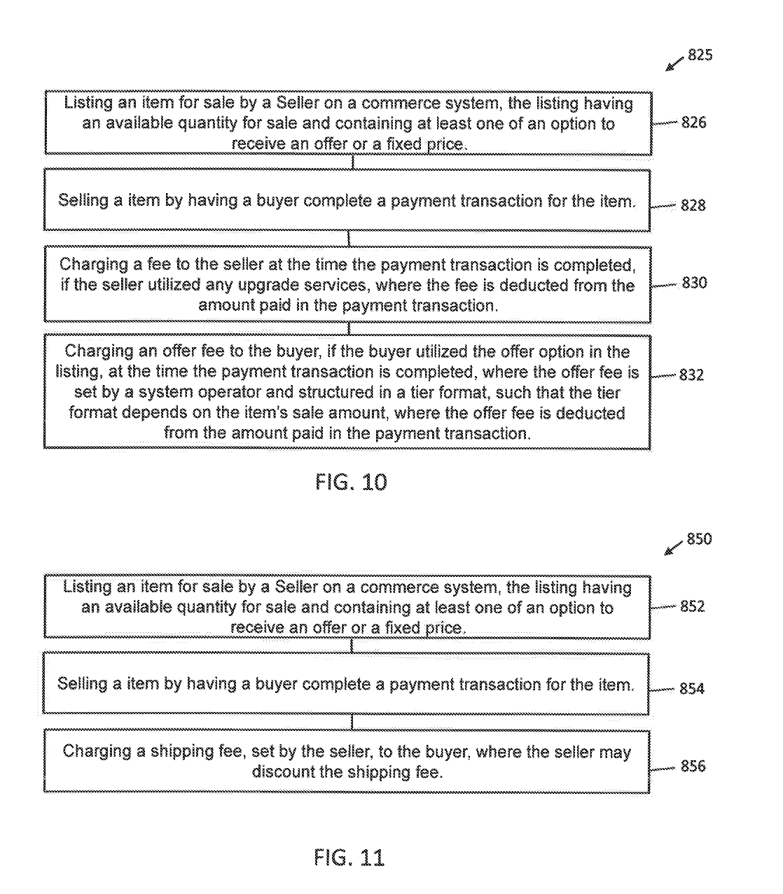

FIG. 10 is a process flowchart showing the calculation and application of an offer tier fee structure as applied to a transaction and is generally referred to as 825. Step 826 lists an item, which is a good or service, by a seller on the commerce system, where the listing has an available quantity and has an option to receive an offer, a fixed price, or both. Next, step 828 has an item being sold by having a buyer complete a payment transaction for the item. Once the buyer completes the payment transaction, step 830 has the Seller charged an upgrade fee, if any upgraded services were used by the Seller for the listing, where the upgrade fee is deducted from the amount paid by the Buyer during the payment transaction. Lastly, in step 832, the buyer is charged a fee only if the Buyer used the offer option in the listing. If the Buyer utilizes the fixed price option, the commerce system will not charge the Buyer any system usage fees. However, the Buyer may still be a charged shipping fee associated with the transaction. For example, the tier fees will vary depend on the offer amount offered by the buyer to the seller. For example, if the buyer makes an offer for 5 jackets at $100 for each jacket, and the Buyer's offers were automatically accepted by the System, the Buyer is immediately taken to a different page to finished the payment transaction. Since the Seller listed the jackets individually in the item listing, the Buyer essentially made five (5) individual offers for the 5 jackets. The payment transaction page will show the total cost consisting of the 5 jackets at $100 each, for a total of $500, along with the tier fees charged for each offer. Since each offer is for $100 per jacket, the $100 offers fall in tier 2 of an ‘offer tier fee’ schedule, which will be $0.59 per jacket. As a result, for this transaction, the Buyer pays $500 for 5 jackets at $100 per jacket and an additional $2.95 for 5 offer fees at $0.59 per jacket for a grand total of $502.95. These fees will be deducted from the amount the Buyer pays during the payment transaction when the Buyer completes the payment transaction

FIG. 11 is a process flowchart showing the application of shipping charges set by the seller and charged to the buyer for each transaction and generally referred to as 850. In step 852, a seller generates a listing on the commerce system having an available quantity and containing at least one of an option to receive an offer or a fixed price. In step 854, an item is sold with the buyer completes the payment transaction. In step 856, the buyer is charged a shipping fee, set by the seller, where the shipping fees may be tiered by the seller. For example, if a buyer purchases at least three (3) of an item in a single transaction, the seller may discount or otherwise reduce the shipping fees. It is to be appreciated by someone skilled in the art that the seller may set a custom tier structure for each individual item listing or even may not implement any tier structure whatsoever.

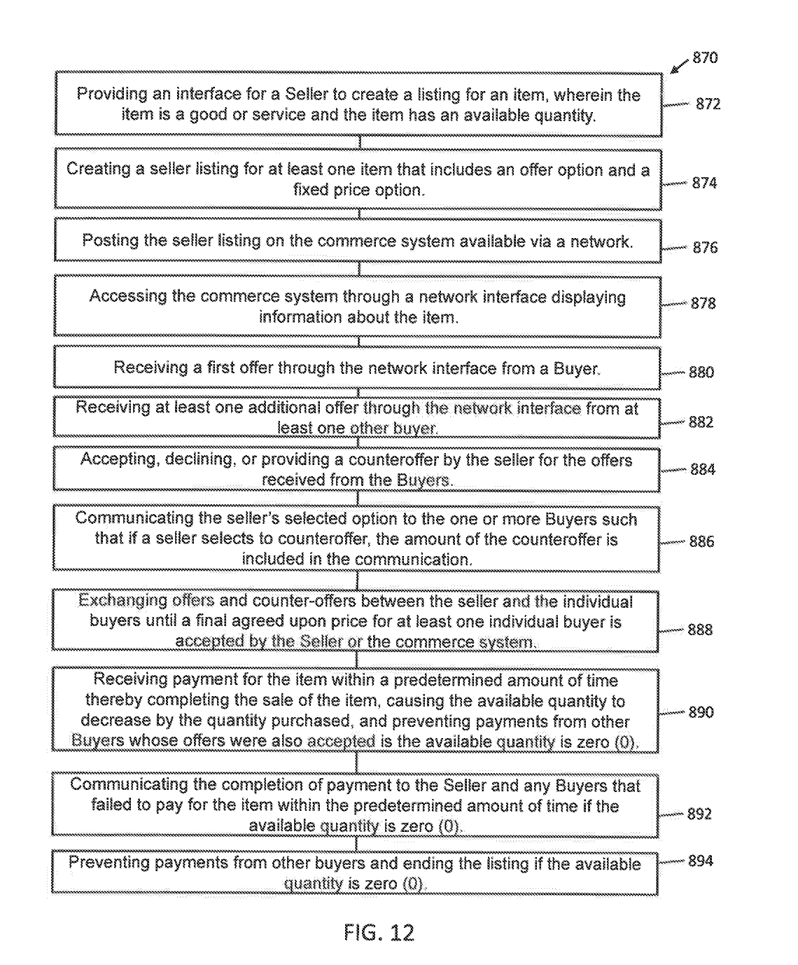

FIG. 12 is a process flowchart showing the process for one or more buyers to make an offer to a seller and is generally referred to as 870. The first step in process 870 is step 872, where the commerce system provides an interface for a seller to create an item listing having an available quantity. Step 874 has the seller creating a listing using the interface, where the listing has an offer option and a fixed price option. The listing is then posted on the commerce system in step 876. In step 878, a user accesses the commerce system through a network interface that displays information about the item. In step 880, the commerce system receives a first offer through the network interface from a buyer. In step 882, the system receives at least one additional offer from at least one additional buyer. Next, in step 884, the seller either accepts, declines, or provides a counteroffer for the offers received from the buyer. In step 886, the commerce system communicates the seller's selected options to the one or more buyers such that if the seller selects to provide a counteroffer, the amount of the counteroffer is included in the communication. Step 888 allows for the seller and the one or more buyers to exchange offers and counteroffers until a final agreed upon price for at least one buyer is accepted by the seller or the commerce system. In step 890, the commerce system receives payment for the item within a predetermined period of time. The item is considered sold when the payment transaction is complete. When the payment transaction is complete, the available quantity is decremented by the amount purchased by the buyer. In step 892, the commerce system communicates to completion of the payment transaction to the seller and any buyers that failed to pay for the item within the predetermined amount of time if the available quantity is zero (0). Lastly, in step 894, the commerce system prevents payments from other buyers for that item is the available quantity is zero (0).

Fees charged by the commerce system of the present invention consist of Buyer's fees and Seller's fees. The commerce system charges Seller's fees for listing an item. The fee structure includes a fee for creating a listing and a fee for each allowed method of purchase for the item, such as Make Me An Offer and Purchase Now. Other fees may include a fee for adding an image to a listing, or a fee for the amount of time a listing is active before the listing ends. In a typical embodiment of the present invention, the Seller pays fees only when an item sells. Some fees, such as the Make Me An Offer fee, are charged as a percentage of the offer amount. This percentage is set by the system operator and, in a typical embodiment, is one percent (1%) of the offer amount. The system charges fees based on the sale of each item, not the total number of items purchased in a transaction. For example, if a Buyer purchases three (3) identical items from a Seller, where the Buyer agrees to pay $100 for each item totaling $300, and the system charges a one percent (1%) fee for each item, the Seller must pay $1 for each item for a total of $3 for the transaction.

In a preferred embodiment of the present invention, the commerce system charges tiered fees to a Buyer. Tier fees are charged only to buyers for the convenience of using the make me an offer fee function. The commerce system bases the tiers on the value of the item purchased by the Buyer. The tier breakpoints and the tier amounts are set by the system operator. In other embodiments, the tiered fees may increase or decrease depending on, for example, the number of items purchased, how often the Buyer buys or the Seller sells, the value of the item(s) purchased, and the number of items purchased in a transaction. The tier fees will vary depend on the offer amount offered by the buyer to the seller. For example, if the buyer makes an offer for 5 jackets at $100 for each jacket, and the Buyer's offers were automatically accepted by the System, the Buyer is immediately taken to a different page to finished the payment transaction. Since the Seller listed the jackets individually, the Buyer essentially made five (5) individual offers for the 5 jackets. The payment transaction page will show the total cost consisting of the 5 jackets at $100 each, for a total of $500, along with the tier fees charged for each offer. Since each offer is for $100 per jacket, the $100 offers fall in tier 2 of an ‘offer tier fee’ schedule, which will be $0.59 per jacket. As a result, for this transaction, the Buyer pays $500 for 5 jackets at $100 per jacket and an additional $2.95 for 5 offer fees at $0.59 per offer for a grand total of $502.95.

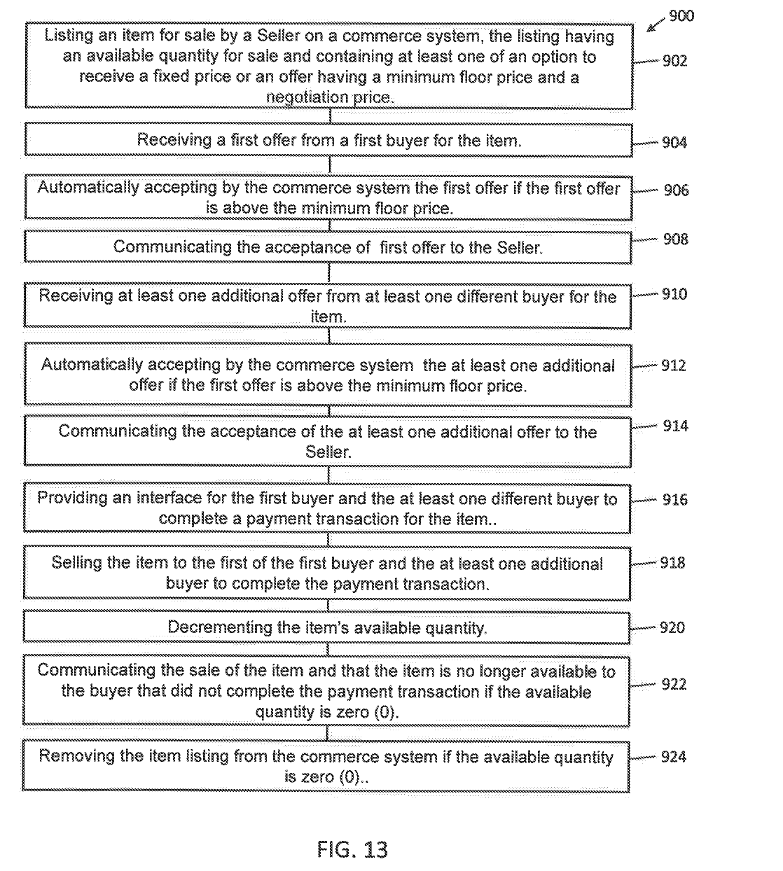

Referring now to FIG. 13, a process flowchart showing the automatic acceptance of multiple offers by the commerce system is shown and generally referred to as 900. Starting in step 902, a Seller creates an item listing on the commerce system, where the listing has an available quantity for sale and an option to receive a fixed price for the item, the option of receive offers from potential Buyers, or both. The offer option also has a minimum floor price and a negotiation price. Step 904 has the commerce system receiving a first offer from a first buyer for the item identified in step 902. In step 906, the commerce system automatically accepts the first offer if the first offer is above the minimum floor price. The commerce system then communicates the acceptance of the first offer to the Seller in step 908. In step 910, the commerce system receives at least one additional offer from at least one different buyer for the item identified in step 902. In step 912, the commerce system automatically accepts the at least one additional offer from the at least one different buyer is the offer price is above the minimum floor price. The commerce system then communicates the acceptance of the at least one additional offer to the Seller in step 914. In step 916, the commerce system provides an interface for the buyers (the first buyer and the at least one different buyer) to complete a payment transaction for the purchase of the item. Step 918 has the commerce system selling the item to the first buyer to complete the payment transaction. After the payment transaction is completed in step 918, the commerce system decrements the item's available quantity. If the available quantity of the item is decremented to zero (0) in step 918, the commerce system communicates the sale of the item and that the item is no longer available to the buyer that failed to complete the payment transaction. Lastly, in step 924, the commerce system removes the listing from the commerce system if the available quantity is zero (0). It is to be appreciated by someone skilled in the art that if the available quantity exceeds the number of accepted offers for an item, then any buyers that complete the payment transaction after the first completed payment transaction will not receive a notification from the commerce system as described in step 922. Further, it is to be appreciated by someone skilled in the art that the commerce will not remove the item listing if the available quantity is greater than zero (0) since there is a quantity available to satisfy any new purchases from buyers.

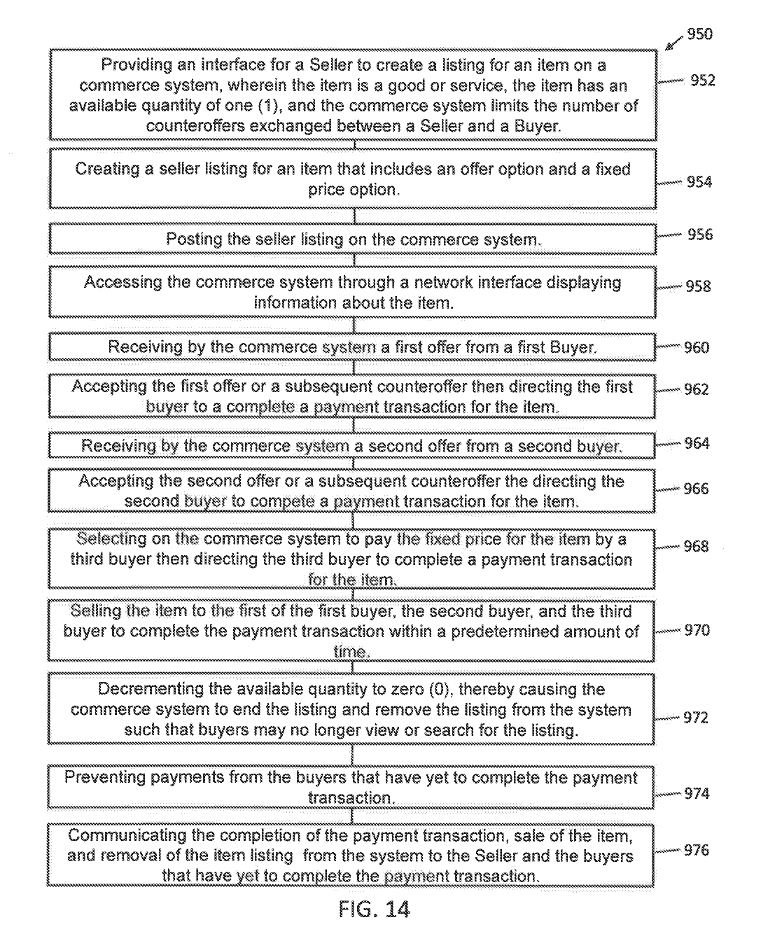

Lastly, referring to FIG. 14, a process flowchart showing the process of receiving multiple offers and a fixed price purchase is shown and generally referred to as 950. Process 950 starts at step 952 with a commerce system providing an interface of a Seller to create an item listing, where the listing has an available quantity of one (1), and the commerce system is configured to limit the number of counteroffers a Seller and Buyer are allowed to exchange. In step 954, a seller creates a seller listing for an item that includes an offer option and a fixed price option. Step 956 posts the seller listing on the commerce system, where the commerce system is accessible via a network. In step 958, the commerce system is accessed through a network interface displaying information about the item. Step 960 has the commerce system receiving a first offer from a first buyer, where, in step 962, the commerce accepts the first offer, or a subsequent counter-offer agreed to by the seller and the first buyer, then directs the first buyer to complete a payment transaction for the item. In step 964, the commerce system receives another, or second, offer from a second buyer. Step 966 has the commerce system accepting the second offer, or a subsequent counter-offer agreed to by the seller and the second buyer, then directs the second buyer to complete a payment transaction for the item.

In step 968, a third buyer selects on the commerce system to pay the fixed price for the item, where the third buyer is also directed to complete a payment transaction for the item. Step 970 has the commerce system selling the item to the first of the first buyer, the second buyer, or the third buyer to complete the payment transaction for the item. As a result of the sale to the buyer who is the first to complete the payment transaction, step 972 decrements the available quantity to zero (0) since the item had an original available quantity of one (1). As a result of the available quantity being decremented to zero (0), the commerce system automatically ends the listing and removes the listing from the commerce system such that Buyers may no longer view or search for the listing. Once the commerce system ends the listing, the commerce system prevents or blocks any buyers that agreed to purchase the item but have yet to complete the payment transaction from completing the payment transaction. Lastly, in step 976, the commerce system communicates the completion of the payment transaction, sale of the item, and removal of the item listing from the commerce system to the Seller and any Buyers that agreed to purchase the item but have yet to complete the payment transaction.

Put another way, process 950 allows a seller to accept an offer or counteroffer from one or more Buyers as well as allowing one or more buyers to agree to buy the item for the fixed price. Once a Buyer agrees to purchase the item, the Buyers become committed Buyers. When multiple committed buyers are involved in the process, the commerce system will sell the single item to whichever committed Buyer completes the payment transaction first. Once the committed Buyer completes the payment transaction, the commerce system will stop any other committed Buyers from completing the payment transaction since the single item has already been sold to the committed Buyer who completed the payment transaction first. The commerce system also removes the listing such that the listing is no longer viewable or searchable. Once the commerce system completes the sale by receiving payment, it communicates the sale of the item to the Seller and all committed Buyers informing them the item has sold and is no longer available for purchase.

Other functions of the commerce system of the present invention are described below. The commerce system may include functionality to support nonprofit groups and schools by allowing users to donate money to the nonprofit or school. The system may also allow funds to be collected for a specific cause, such as for a sick or injured child, or for a preservation project, such as for preservation a park or a historical landmark. The commerce system lists nonprofits and other related organizations by mission, location, portion of donated amounts used to operate the nonprofit or organization, deadlines, and allowed donation amounts. In certain instances, stipulations may be attached to a donated amount. For example, someone may donate money to a school but may stipulate that the funds may only go to the construction or renovation of a gymnasium or for the installation of modern technology in classrooms.

In supporting a Seller, the commerce system provides the Seller with the ability to set prices, time and date the offer ends, cancellation of listings, delivery restrictions, shipping charges, and method of listing an item. If a Seller is a “Mom and Pop” business, e.g. a sole proprietorship or a small business, the commerce system lists such businesses by certain criteria such as by state, city, area code, special offers available, and available reservations. If the “Mom and Pop” provides a service, such as home painting, yoga instruction, or a restaurant, the commerce system displays available time slots for a user to purchase. The commerce system also allows the business owner to manage the reservations including appointment cancellations, which may include charging a fee for a purchaser to change or cancel an appointment. The Seller may also adjust the listing to only charge a cancellation or change fee if certain conditions are met, such as if the cancellation or change is within 24 hours of the appointment time. The Seller also has the discretion not to charge a change or cancellation fee on a case-by-case basis.

If the Seller is a wholesaler, the commerce system can list the wholesalers by the number of units available for purchase, available package deals, shipping costs, sales goals, and the type of items listed. If the wholesaler creates an offer containing multiple items, the fees charged by the commerce system depend only on the purchase price of the offer and not on the value of the individual items.

It is to be appreciated by one skilled in the art that for any transaction associated with the commerce system of the present invention, a Buyer may not purchase more items than indicated by the then current available quantity. If a Buyer attempts to purchase more items than are currently available, the commerce system will alert the Buyer that there are not enough of the items available to satisfy the Buyer's request and that the number of items requested by the Buyer must be adjusted to be equal to or less than the then available quantity.

It is also to be appreciated by one skilled in the art that the purchase and payment processes discussed above may be practiced in varying combinations with each other during operation of the commerce system and that some of the processes are optional while others are mandated by the system operator. For example, a Buyer may not opt out of the “strike” system disclosed in FIG. 4 but may choose to list their items using the fixed price option disclosed in FIG. 3, the offer option disclosed in FIG. 2, or a combination of the processes disclosed in FIG. 2 and FIG. 3. As another example, a seller may not opt out of the “FLAG” system but may choose to list an item using the fixed price or the offer option and may choose to include a restock alert. It is fully contemplated that the features and functions of one embodiment may be combined with features and functions from another embodiment without departing from the spirit and scope of the present invention.

While the particular commerce system as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A method of transacting an item using an interface generated by a commerce system connected to a network to create a listing, the listing comprising information related to the item, the method comprising the steps of:
creating a listing by a seller for one item for sale, the listing including:
an indication for an available quantity of the item, where the available quantity is one (1);
a means to select a fixed price option where the fixed price option contains a fixed price viewable in the listing; and
a means to select an offer option for a buyer to make an offer for the item, where the offer option further comprises;
a means for entering an offer price;
a minimum floor price, which is not displayed or communicated to a Buyer viewing the listing; and
a negotiation price, which is not displayed or communicated to a Buyer viewing the listing;
posting the seller listing on the commerce system such that it is viewable and searchable on the commerce system;
accessing the commerce system by one or more Buyers through the network, wherein the commerce system displays the information related to the item to the one or more buyers;
receiving by the commerce system at least one of one or more agreements to pay the fixed price and one or more offers from the one or more buyers;
communicating the at least one of the one or more agreements to pay the fixed price and the one or more offers to the seller;
providing the seller a means to individually accept, decline, or provide a counteroffer to the one or more offers, where the seller utilizes the means to accept, decline, or provide a counteroffer to the one or more offers, wherein the acceptance of one or more offers or counteroffers creates accepted offers;
providing a means for the one or more Buyers having an accepted offer or have agreed to pay the fixed price to complete a payment transaction for the item;
selling the item to the first Buyer having an accepted offer or agreement to pay the fixed price who completes the payment transaction;
preventing the remaining Buyers having an accepted offer or an agreement to pay the fixed price from completing the payment transaction;
decrementing the item's available quantity to zero (0);
ending the listing by the commerce system such that the item listing is no longer displayed or searchable by any buyer; and
communicating the completion of the payment transaction and the ending of the listing to the Seller and all Buyers.

2. The method of claim 1, wherein the item listing further includes a description of the item, where the description may include an image of the item.

3. The method of claim 1, wherein the Buyer having an accepted offer or an agreement to pay the fixed price must complete the payment transaction within a predetermined period of time.

4. The method of claim 3, wherein the accepted offer expires if the payment transaction is not completed within the predetermined period of time.

5. The method of claim 1, wherein the commerce system limits the number of counteroffers exchanged between the Seller and a Buyer.

6. The method of claim 1, further comprising the step of communicating from the commerce system to the Buyer who completes the payment transaction the successful completion of the payment transaction and item purchase.

7. The method of claim 1, further comprising the step of a Buyer “FLAGGING” a Seller who fails to perform his or her duties as a sever, thereby incrementing a “FLAG” counter.

8. The method of claim 7, further comprising the step of suspending the Seller's account when the “FLAG” counter exceeds a predetermined number set by an operator of the commerce system.

9. The method of claim 8, further comprising the step of reactivating a Seller's account at the discretion of the operator of the commerce system.

10. The method of claim 1, further comprising the step of a Seller causing a Buyer's “STRIKE” counter to increment for failing to perform his or her agreed upon duties associated with the transaction.

11. The method of claim 10, further comprising the step of suspending further transactions with the Buyer when the Buyer's “STRIKE” counter exceeds a predetermined number set by an operator of the commerce system.

12. The method of claim 11, further comprising the step of reinstating further transactions with the Buyer.

13. A method of operating a commerce system configured to transact an item through an item listing, the commerce system connected to a network, and the listing comprising information related to the item, the method comprising the steps of:
creating a listing by a seller for an item for sale, the listing including:
an indication for an available quantity of the item, where the available quantity is two (2) or more;
a means to select a fixed price option where the fixed price option contains a fixed price viewable in the listing; and
a means to select an offer option for a buyer to make an offer for the item, where the offer option further comprises;
a means for entering an offer price;
a minimum floor price, which is not displayed or communicated to a Buyer viewing the listing; and
a negotiation price, which is not displayed or communicated to a Buyer viewing the listing;
posting the seller listing on the commerce system such that it is viewable and searchable on the commerce system;
accessing the commerce system by one or more Buyers through the network, wherein the commerce system displays the information related to the item to the one or more buyers;
receiving by the commerce system at least one of one or more agreements to pay the fixed price and one or more offers from the one or more buyers;
communicating the at least one of the one or more agreements to pay the fixed price and the one or more offers to the seller;
providing the seller a means to individually accept, decline, or provide a counteroffer to the one or more offers, where the seller utilizes the means to accept, decline, or provide a counteroffer to the one or more offers, wherein the acceptance of one or more offers or counteroffers creates accepted offers;
providing a means for the one or more Buyers having an accepted offer or have agreed to pay the fixed price to complete a payment transaction for the item;
selling at least one of, but not more than, the available quantity of the item to a first Buyer having an accepted offer or agreement to pay the fixed price who completes the payment transaction;
decrementing the quantity available by the commerce system by the amount sold to the first Buyer;
communicating the completion of the payment transaction by the first Buyer to the Seller;
ending the listing by the commerce system if the commerce system decrements the available quantity to zero, preventing any remaining Buyers having an accepted offer or an agreement to pay the fixed price, and communicating to the remaining Buyers that the item has been sold and is no longer available;
selling at least one of, but not more than, the available quantity of the item to a second Buyer having an accepted offer or an agreement to pay the fixed price who completes the payment transaction;
decrementing the available quantity by the commerce system by the amount sold to the second Buyer;
communicating the completion of the payment transaction by the second Buyer to the Seller;
ending the listing by the commerce system if the commerce system decrements the available quantity to zero, preventing any remaining Buyers having an accepted offer or an agreement to pay the fixed price, and communicating to the remaining Buyers that the item has been sold and is no longer available;
allowing additional Buyers to purchase at least one, but not more than the available quantity, of the item, wherein the commerce system decrements the available quantity by the amount sold to each additional Buyer, and the commerce system ends the listing when the commerce system decrements the available quantity until the available quantity is zero (0); and
communicating the ending of the item listing to any Buyer having an accepted offer or agreed to pay the fixed price.

14. The method of claim 13, wherein the Buyer having an accepted offer or an agreement to pay the fixed price must complete the payment transaction within a predetermined period of time.

15. The method of claim 14, wherein the Buyer's accepted offer or agreement to pay the fixed price expires if the payment transaction is not completed within the predetermined period of time.

16. The method of claim 13, wherein the commerce system limits the number of counteroffers exchanged between a Seller and a Buyer.

17. A method of tracking the performance of a Buyer's and a Seller's duties associated with a transaction of an item listing on a commerce system, the method comprising the steps of:
identifying a transaction where the Buyer or the Seller fails to perform their agreed upon duties associated with the transaction;
incrementing a counter specifically associated with the Seller or the Buyer;
notifying the Seller or the Buyer that the commerce system has incremented the counter specifically associated with that Seller or Buyer;
comparing the counter to a predetermined number set by an operator of the commerce system;
suspending further transactions involving the Seller or the Buyer associated with the counter when the counter equals or exceeds the predetermined number; and
notifying the Seller or the Buyer that he or she has been suspended on the commerce system.

18. The method of claim 17, further comprising the step of reinstating a Seller or Buyer at the discretion of an operator of the commerce system.

19. The method of claim 17, further comprising the step removing a Seller's listing from the commerce system when the counter specifically associated with the Seller equals or exceeds the predetermined number.

20. The method of claim 17, further comprising the steps of:
starting a probationary period upon the incrementing of the counter specifically associated with the Buyer;
providing to the Buyer, from the commerce system, a set of criteria for decrementing the counter specifically associated with the Buyer during the probationary period;
decrementing the counter specifically associated with the Buyer at the end of the probationary period if the criteria for decrementing the counter specifically associated with the Buyer have been met by the Buyer;
starting a new probationary period upon completion of a previous probationary period if the counter specifically associated with the Buyer is greater than zero (0); and
allowing a Buyer to complete the set of criteria during each probationary period, then decrementing the counter specifically associated with the Buyer at the end of each probationary period until the counter specifically associated with the Buyer is decremented to zero (0).
